(19) United States
(12) Patent Application Publication
(10) Pub. No.: US 2010/0231505 A1
(43) Pub. Date: Sep. 16, 2010

(54) INPUT DEVICE USING SENSORS MOUNTED ON FINGER TIPS

(76) Inventor: Haruyuki Iwata, Chiba (JP)

Correspondence Address: Studebaker & Brackett PC, One Fountain Square, 11911 Freedom Drive, Suite 750, Reston, VA, 20190, US

(21) Appl. No.: 12/299,355

(22) PCT Filed: May 2, 2007
(86) PCT No.: PCT/JP2007/059378

§ 371 Date: Feb. 3, 2009

(30) Foreign Application Priority Data
May 5, 2006 (JP) 2006-154022

(51) Int. Cl. G09G 5/00

(52) U.S. Cl. 345/156

(57) ABSTRACT

In order to allow key input without operation of a keyboard or allow click and drag operations by finger tips of the hands, the present invention is primarily characterized in that a user wears a glove (7) (including a glove that covers only finger tips), which has a motion detection sensor (4) (based on the same principle as a laser mouse or an optical mouse) and a tactile sensor (5) (a conductive rubber, a piezoelectric element or the like) mounted on each finger-tip part thereof, on each hand (like mounting a small laser mouse or optical mouse on each finger tip), motion information about each finger tip is transmitted to an information processing device, such as a personal computer (PC), a PDA and a cellular phone, the position of each finger tip is displayed on a virtual keyboard (2) shown on a display (3) of the information processing device, and the tactile sensor (5) detects the pressure on a finger tip when the finger tip is pressed against an arbitrary object, such as a desk, thereby allowing input of a key corresponding to the finger tip pressed against the arbitrary object.

### TECHNICAL FIELD

The present invention relates to an input device using sensors mounted on finger tips that allows key input without using a conventional keyboard or allows a click or drag operation via finger tips of the hands.

### BACKGROUND ART

A conventional virtual keyboard input device has an infrared sensor installed on top of a portable computer, such as a cellular phone, and recognizes the motions of fingers based on image processing (see the Patent Document 1, for example).

However, as with the conventional keyboards, the keyboard input device has restrictions as to the position during operation, such as fingers of the hands have to be placed on the keyboard. In addition, depending on the environmental condition (the background, the illumination or the like), it is difficult to accurately recognize the motions of fingers by image processing.

Patent Document 1: Japanese Patent Laid-Open No. 2005-258482

### DISCLOSURE OF THE INVENTION

### Problems to be Solved by the Invention

A problem to be solved by the present invention is that there is a limit to the degree of miniaturization of keyboards used for key input for reasons of operability, despite the fact that the main unit and display of various information processing devices, such as personal computers (PC), PDAs and cellular phones, are increasingly miniaturized. Another problem to be solved by the present invention is that conventional keyboards have positional restrictions, such as finger tips of the hands have to be placed on the keyboard, so that it is difficult for a sick person to use the keyboard in bed, for example.

The present invention is intended to solve the problems described above, and an object of the present invention is to allow key input without actual operation of a keyboard and allow click and drag operations via finger tips of the hands.

### Means for Solving the Problems

The present invention is primarily characterized in that, in order to allow key input without operation of a keyboard, a user wears a glove (7) (including a glove that covers only finger tips), which has a motion detection sensor (4) (based on the same principle as a laser mouse or an optical mouse) and a tactile sensor (5) (a conductive rubber, a piezoelectric element or the like) mounted on each finger-tip part thereof, on each hand (like mounting a small laser mouse or optical mouse on each finger tip), motion information about each finger tip is transmitted to an information processing device, such as a personal computer (PC), a PDA and a cellular phone, the position of each finger tip is displayed on a virtual keyboard (2) shown on a display (3) of the information processing device, and the tactile sensor (5) detects the pressure on a finger tip when the finger tip is pressed against an arbitrary object, such as a desk, thereby allowing input of a key corresponding to the finger tip pressed against the arbitrary object. A home position for an index finger is set on the virtual keyboard (2) shown on the display (3) as with an ordinary keyboard, a cursor corresponding the index finger is displayed at the home position, and cursors corresponding to the remaining fingers are displayed adjacent thereto so that the user can feel as if the user actually puts his/her finger tips on the virtual keyboard (2) shown on the display (3). In this state, the tactile sensor (5) detects the pressure on the finger tip pressed against the arbitrary object, such as a desk, to allow key input to word processing application software (1) or the like in the information processing device. The input device can additionally have an information security capability by incorporating a fingerprint recognition feature in a case where the glove covers only the finger tips or a fingerprint or vascular recognition feature in a case where the glove covers the entire hand.

Second means of solving the problems is primarily characterized in that a user wears a glove (7) (including a glove that covers only finger tips), which has a motion detection sensor (4) (based on the same principle as a laser mouse composed of a laser sensor (8) and a laser diode (9) or an optical mouse composed of an optical sensor (10), a light emitting diode (LED) (12) and a lens (11)) and a tactile sensor (5) (a conductive rubber, a piezoelectric element or the like) mounted on each finger-tip part thereof, on each hand (like mounting a small laser mouse or optical mouse on each finger tip), motion information about each finger tip is transmitted to an information processing device, such as a personal computer (PC), a PDA and a cellular phone, the position of each finger tip is displayed on a display (3) of the information processing device, and the tactile sensor (5) detects the pressure on a finger tip when the finger tip is pressed against an arbitrary object, such as a desk, thereby allowing the same operations as click and drag operations of an ordinary mouse. The input device can additionally have an information security capability by incorporating a fingerprint recognition feature in a case where the glove covers only the finger tips or a fingerprint or vascular recognition feature in a case where the glove covers the entire hand.

### Advantages of the Invention

Since the keyboard, which has been difficult to miniaturize, can be omitted, various information processing devices can be further reduced in size and weight.

If the input device is used in combination with a head mounted display (HMD) (13) or the like, wearable computing can be achieved.

The input device has less positional restrictions. For example, a sick person can perform an input operation in any posture in bed. Thus, the input device is expected to be advantageous in terms of welfare.

If a user carries the input device according to claim 1 or 2 incorporating a fingerprint or vascular recognition feature and can access shared information processing devices installed at various places, it makes a great contribution to the realization of the ubiquitous computing society. For example, the user can create a text longer than e-mails or the like created on conventional cellular phones at any time anywhere.

The input device according to claim 2 allows an input operation by the finger tips of the hands, so that a new operation, which would be impossible with the conventional single cursor, becomes possible. In particular, the input device is expected to be advantageous in the field of entertainment, such as computer games.

### BRIEF DESCRIPTION OF THE DRAWINGS

FIG. 1 is a diagram for illustrating an implementation of the whole of an input device (in a case of virtual keyboard input);

FIG. 2 is a diagram for illustrating an implementation of a finger-tip part of an input device of laser type;

FIG. 3 is a diagram for illustrating an implementation of a finger-tip part of an input device of optical type;

FIG. 4 is a diagram for illustrating an implementation of the whole of an input device (in a case of click and drag operations); and

FIG. 5 is a diagram for illustrating an implementation of an input device used in combination with a head mounted display (HMD).

### BEST MODE FOR CARRYING OUT THE INVENTION

The object of allowing key input without operation of a keyboard is achieved by a user wearing a glove (7) (including one that covers only the finger tips), which has a motion detection sensor (4) (based on the same principle as a laser mouse composed of a laser sensor (8) and a laser diode (9) or an optical mouse composed of an optical sensor (10), a light emitting diode (LED) (12) and a lens (11)) and a tactile sensor (5) (a conductive rubber, a piezoelectric element or the like) mounted on each of the finger-tip parts thereof, on each hand (like mounting a small laser mouse or optical mouse on each finger tip), the sensors transmitting motion information about the finger tips to an information processing device, such as a personal computer (PC), a PDA and a cellular phone, the information processing device displaying the positions of the finger tips on a virtual keyboard (2) shown on a display (3) thereof, the tactile sensors (5) detecting the pressure on the finger tips when the finger tips are pressed against an arbitrary object, such as a desk, and the information processing device inputting the key corresponding to the finger tip pressed against the arbitrary object. Furthermore, the same operations as ordinary click and drag operations using a mouse are achieved by a user wearing a motion detection sensor (4) and a tactile sensor (5) on each of the finger tips of his/her hands, the sensors transmitting motion information about the finger tips to an information processing device, such as a personal computer (PC), a PDA and a cellular phone, the information processing device displaying the positions of the finger tips on a display (3) thereof, and the tactile sensors (5) detecting the pressure on the finger tips when the finger tips are pressed against an arbitrary object, such as a desk.

### Embodiment 1

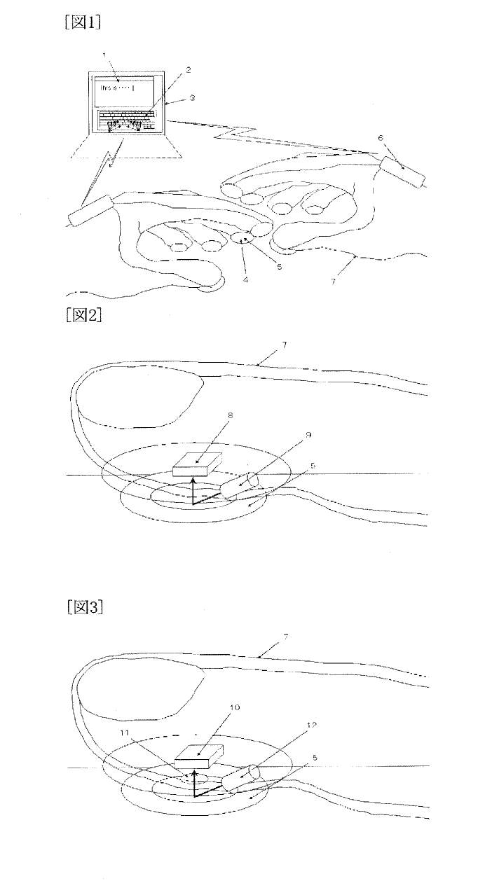

FIG. 1 is a diagram showing the whole of an input device according to the present invention in a case where the input device is implemented as a virtual keyboard input device.

FIG. 2 is a diagram for illustrating a case where a finger-tip part according to the present invention is composed of a laser sensor (8). The motions of the finger tips are detected by recognizing the texture or irregularity of a desk, clothes or the like based on the same principle as a laser mouse composed of the laser sensor (8) and a laser diode (9), and information about the motions is transmitted to a personal computer (PC) or the like. More specifically, images of what lies beneath the finger tips are regularly stored, the images for the same finger tip before and after motion are compared to calculate the amount and direction of motion of the finger tip, and the calculation result is transmitted to the personal computer (PC) or the like. When a finger tip is pressed against a desk or the like, a tactile sensor (5) composed of a conductive rubber, a piezoelectric element or the like detects the pressure on the finger tip to determine which finger is pressed and transmits a signal to the personal computer (PC) or the like.

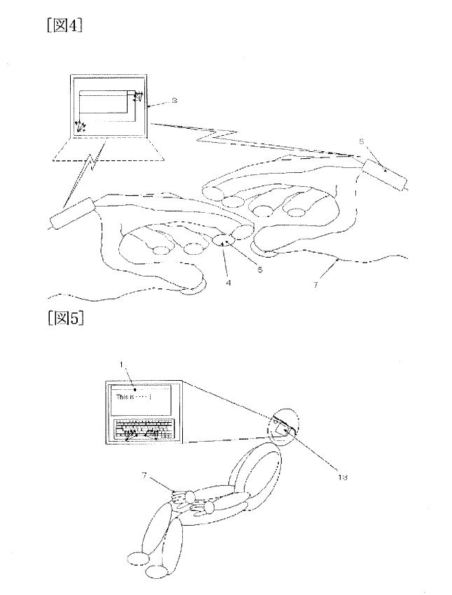

FIG. 3 is a diagram for illustrating a case where a finger-tip part according to the present invention is composed of an optical sensor (10). The motions of the finger tips are detected by recognizing the texture or irregularity of a desk, clothes or the like based on the same principle as an optical mouse composed of the optical sensor (10), a light emitting diode (LED) (12) and a lens (11) and information about the motions is transmitted to a personal computer (PC) or the like. More specifically, images of what lies beneath the finger tips are regularly stored, the images for the same finger tip before and after motion are compared to calculate the amount and direction of motion of the finger tip, and the calculation result is transmitted to the personal computer (PC) or the like. When a finger tip is pressed against a desk or the like, a tactile sensor (5) composed of a conductive rubber, a piezoelectric element or the like detects the pressure on the finger tip to determine which finger is pressed and transmits a signal to the personal computer (PC) or the like.

### Embodiment 2

FIG. 4 is a diagram showing the whole of the input device according to the present invention in a case where the input device is used to achieve click and drag operations.

### INDUSTRIAL APPLICABILITY

The input device according to the present invention can achieve key input, click and drag operations via sensors mounted on finger tips and can be applied in situations where physical keyboard operations are generally required.

1. A virtual keyboard input device having no actual keys that allows key input without operation of a keyboard, in which a user wears a glove covering at least the users finger tips, which has a motion detection sensor comprising a laser mouse or an optical mouse and a tactile sensor mounted on each finger-tip part thereof, on each hand, motion information about each finger tip is transmitted to an information processing device, such as a personal computer (PC), a PDA and a cellular phone, the position of each finger tip is displayed on a virtual keyboard shown on a display of the information processing device, and the tactile sensor detects the pressure on a finger tip when the finger tip is pressed against an arbitrary object, such as a desk, thereby allowing input of a key corresponding to the finger tip pressed against the arbitrary object, wherein a home position for an index finger is set on the virtual keyboard shown on the display as with an ordinary keyboard, a cursor corresponding to the index finger is displayed at the home position, and cursors corresponding to the remaining fingers are displayed adjacent thereto so that the user can feel as if the user actually puts his/her finger tips on the virtual keyboard shown on the display.

2. An input device, in which a user wears a glove covering at least the users finger tips, which has a motion detection sensor comprising a laser mouse or an optical mouse and a tactile sensor mounted on each finger-tip part thereof, on each hand motion information about each finger tip is transmitted to an information processing device, such as a personal computer (PC), a PDA and a cellular phone, the position of each finger tip is displayed on a display of the information processing device, and the tactile sensor detects the pressure on a finger tip when the finger tip is pressed against an arbitrary object, such as a desk, thereby allowing the same operations as click and drag operations of an ordinary mouse.

3. The input device as claimed in claim 1 wherein the input device can additionally have an information security capability by incorporating a fingerprint recognition feature in a case where the glove covers only the finger tips or a fingerprint or vascular recognition feature in a case where the glove covers the entire hand.

4. The input device as claimed in claim 2 wherein the input device can additionally have an information security capability by incorporating a fingerprint recognition feature in a case where the glove covers only the finger tips or a fingerprint or vascular recognition feature in a case where the glove covers the entire hand.
